(19) United States
(12) Patent Application Publication
(10) Pub. No.: US 2010/0082695 A1
(43) Pub. Date: Apr. 1, 2010

(54) ENTERPRISE SOCIAL GRAPH AND CONTEXTUAL INFORMATION PRESENTATION

(76) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(21) Appl. No.: 12/566,800

(22) Filed: Sep. 25, 2009

Related U.S. Application Data
(60) Provisional application No. 61/100,288, filed on Sep. 26, 2008.

(51) Int. Cl. G06F 7/10; G06F 17/30

(52) U.S. Cl. 707/798; 707/E17.108

(57) ABSTRACT

A system for aggregating social graph information uses both social networking and social media sites as well as optional access to enterprise data so that a detailed and comprehensive social graph can be generated. The social graph information is provided to users when contextually appropriate. Other contextually appropriate information can be displayed to users as they undertake different tasks.

### CROSS REFERENCE TO RELATED APPLICATIONS

This application claims the benefit of priority from U.S. Provisional Patent Application No. 61/100,288 entitled “Enterprise Social Graph and Contextual Information Presentation” filed Sep. 26, 2008, the contents of which are expressly incorporated herein by reference.

### FIELD OF THE INVENTION

This invention relates generally to the use of social graph and other contextual information as an enhancement to activities such as Internet browsing, communication and other data driven tasks.

### BACKGROUND OF THE INVENTION

Social networking allows users of a social networking service to link to other users, and create a cloud of connections. Often these connections are depicted as being in concentric rings, with individuals that the user is directly connected to being closest to the user, and then having an expanding network based on the connections of the inner ring. This information is considered to be the basic formational structure of a social graph for a user. A social graph allows the user to connect to people using intermediate contacts as a bridge where necessary. The value of social graph information is well known in the art.

Typically, social graph information for a user is fragmented and stored through a number of distinct social networking sites. Each of these different social networking sites often have only limited interaction with each other. A user who makes use of a plurality of social networking sites often has a different social graph at each site despite the fact that there are often overlapping contacts in each social graph.

There is a rich depth of information that can be obtained from an individual's social graph, but the scattered nature of the information makes it difficult to access. The information is often in a silo requiring that the user first determine that there is a need to access the social information and then requires that the user initiate a search for the relevant information. This interrupts the user's workflow and the inconvenience often prevents the user from accessing social information when it may be beneficial. Relevant information is not presented to the user as an element of a standard application as the user works.

Often in addition to the contact information stored by a user in a social networking site, other contextual information is available but remains un-accessed by most users. Both intrinsic and extrinsic contextual information is both intrinsic and extrinsic to anis associated with every document used or stored by the user. A webpage about a company may have contextual information in the form of news stories about the company, stock prices for the company if it is listed, and social information revealing how the user is connected to people in the company through a social graph. For most websites, publicly available security ratings are a form of contextual information that is typically only available through proprietary applications. Because these proprietary applications require user interaction outside of a normal workflow they are less useful for most users. Documents available to a user over a network also contain intrinsic contextual information such as the last person to perform an edit, the group of people who are authorized to edit a document, and other related information. At present, this information, when available, is only accessible to a user through the execution of extra commands, and is often not available while a user is viewing the document, rendering the contextual data of lesser value.

It is clear that the social graph information built by a user is fragmented across a number of resources and often fails to collect contextual information that can either make the social graph more complete or that can have enhanced meaning when put in the context of the social graph information. It is, therefore, desirable to provide a mechanism for viewing social graph related and other contextual information during other activities.

### SUMMARY OF THE INVENTION

It is an object of the present invention to obviate or mitigate at least one disadvantage of the prior art.

In a first aspect of the present invention there is provided an enterprise social graph generator for generating a social graph for a user. The generator comprises an enterprise data filter and a social graph aggregator. The enterprise data filter receives information from a plurality of enterprise specific data sources and provides as an output, contact information extracted from the enterprise specific data sources in accordance with a set of policies determined in accordance with an identity of the user. The social graph aggregator receives the extracted contact information from the data filter and creates a social graph based on connections to the extracted contacts, the graph ordered based on the proximity of each of the contacts to the user, each contact being directly connected to either the user or another contact.

In an embodiment of the present invention, the generator further includes a social network interface for obtaining social graph information associated with the user from at least one external social networking site, and for providing the obtained social graph information to the social graph aggregator for use in creating the graph. In an alternate embodiment, the social graph aggregator includes means to identify duplicate connections to a contact, and means to express connection strength based on the number of connections to a contact. In a further embodiment, the filter includes an interface for receiving enterprise specific information from a repository of communication logs, where optionally the repository of communication logs includes connection information obtained from at least one of telephone calls, instant messages and email messages. In another embodiment, the filter includes an interface for receiving enterprise specific information from a repository of directory information where optionally the repository of directory information includes Lightweight Directory Access Protocol information. In a further embodiment, the filter includes an interface for receiving enterprise specific information from an organizational chart where optionally the filter employs information from the organizational chart to user access rights to information obtained from other enterprise data sources. In a further embodiment, the filter includes an interface for receiving enterprise specific information from mailing lists.

In a second aspect of the present invention, there is provided a method of creating a social graph for a user based on enterprise specific data. The method comprises the steps of receiving enterprise based connection data; filtering the received connection data to identify connections between the user and contacts contained in the received connection data; and aggregating the identified connections to form a social graph.

In an embodiment of the second aspect of the present invention, the step of receiving includes receiving enterprise based connection data from a plurality of data sources, and optionally the plurality of data sources include a messaging repository, a directory repository, a mailing list and an organizational chart and the step of filtering includes excluding information received from the plurality of data sources based on the user's position in the organizational chart. In another embodiment, the step of aggregating the identified connections includes identifying duplicate connections to contacts and indicating the strength of connections to contacts. In a further embodiment, the method further includes the step of receiving social graph information from at least one external social networking site and incorporating the identified connections in the received social graph with the identified connections from the received enterprise data prior to the step of aggregating.

In a third aspect of the present invention, there is provided a contextual information display for displaying contextual information based on metadata and social graph information. The display comprises a social graph information database, an external interface, a processor and a display engine. The social graph information database receives and stores social graph information. The external interface receives an indication of user focus, the processor obtains the indication of user focus from the external interface, obtains contextual information about the object of the user focus, queries the social graph information database for social graph information relevant to the obtained contextual information and creates a context sensitive data set for display. The display engine renders the context sensitive data set on a display.

In an embodiment of the third aspect of the present invention, the display engine includes means for displaying the context sensitive data in a standalone application while the object of the user focus is in a distinct application. In another embodiment, the processor includes means to process file access and ownership information as contextual information and to query the social graph information database for social graph information related to the identity of users who have accessed, modified and have ownership of a file indicated as the object of the user focus, and wherein the display engine includes means for rendering audit information in a window of the standalone application. In another embodiment, the context sensitive information includes social graph information associated with intrinsic and extrinsic contextual information obtained about the object of the user focus.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating the aggregation of social graph information;

FIG. 2 illustrates a screen capture of an embodiment of the present invention providing website security information;

FIG. 3 illustrates a screen capture of an embodiment of the present invention providing social bookmarking information;

FIG. 4 illustrates a screen capture of an embodiment of the present invention providing a site traffic analysis;

FIG. 5 illustrates a screen capture of an embodiment of the present invention providing a connection based social graph;

FIG. 6 illustrates a screen capture of an embodiment of the present invention providing contextually relevant news;

FIG. 7 illustrates a model display of contact information showing connections to the user;

FIG. 8 illustrates an embodiment of the present invention showing social graph contextual information in a document management system;

FIG. 9 illustrates an embodiment of the present invention where the contextual information associated with the social graph is displayed in a window of a separate application;

FIG. 10 illustrates an exemplary embodiment of a system of the present invention; and

FIG. 11 is a flowchart illustrating a method of the present invention.

### DETAILED DESCRIPTION

The present invention is directed to presenting users with relevant information selected based on extracted metadata from webpages, information associated with other tasks and known social graph information.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Existing social graph information is typically fragmented through different social media sites. A user can have a set of contacts on different social networking sites such as LinkedIn, Facebook, Myspace, Plaxo, Del.icio.us, Flickr, Twitter and other such services. Each of these sites contains part of the user's social graph, and each of these parts often overlaps with other parts. Thus, if a user is wondering if he is connected to someone at a particular company, each of the social media sites must be searched until a connection is found. Additionally, because this task is often onerous, users will not perform a search on all fragmented social graphs, and may miss a more direct or appropriate connection. Searching through multiple social graphs is often very time consuming, and for an employee of a company, it only captures a portion of the actual social network.

Social networking sites make use of the notion of connections between people. The connections are often based on users creating a list of connections based on entries in an address book, and then by building out the connections by looking at the people connected to each connection. This is a long and time consuming process, and often it fails to capture the full extent of a person's network, as users are often reluctant, or unable, to upload a corporate address book that contains the listing of all employees in an enterprise.

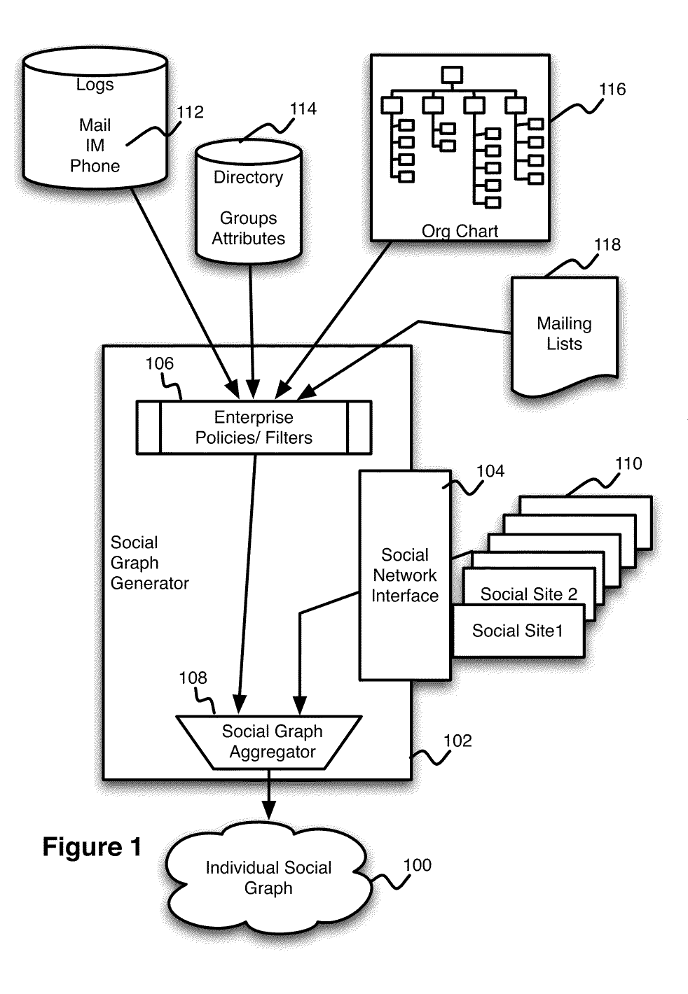

In an enterprise, there is a host of other information sources available other than a fragment of an address book. The system and method of the present invention seek to mitigate user inconvenience. Accordingly an Individual Social Graph 100 is created as illustrated in FIG. 1. Graph 100 is the product of Social Graph Generator 102 which makes use of a Social Network Interface 104, an Enterprise Policy engine/Filter 106 and a Social Graph Aggregator 108. Generator 102 makes use of information available to the user in disparate pieces to create a holistic social graph 100. Social Networking Interface 104 allows generator 102 to interact with a plurality of social networks 110. One skilled in the art will appreciate that in one exemplary interface 104 can be implemented as a series of modules that each make use of the public API associated with an individual social networking site, or in an alternate embodiment the interface 104 can have a defined API that allows each of the plurality of social networks 110 to feed data to generator 102 in a predictable manner. Where interface 104 allows for external information to be aggregated, enterprise information is also employed in creating the social graph 100. Generator 102 uses a filter that is defined by enterprise specific policies 106 to access enterprise resources. One skilled in the art will appreciate that though it may be referred to as an enterprise policy engine element 106 can be used in non-enterprise environments where access to a single user's resources can equally be utilized. Those skilled in the art will appreciate that the discussion of an enterprise environment will be discussed below as it is often a more complex implementation, and a single user environment is simply a social case of the enterprise environment. Logs of email, instant messaging (IM) and telephone calls are often stored by an enterprise in a central repository 112, or are stored in such a manner that this information set can be treated as a single dataset for the purposes of the present discussion. These communication logs stored in repository 112 provide a list of connections that are often missed in social networking site. These need not be the logs of communications directly associated with the user, but instead can be the general communication logs. Whether a particular user will have access to the information associated with another user is based on the policies enforced by policy engine/filter 106. Data directory information and user directories storing group membership and other such attributes associated with user logins can be accessed from directory repository 114, while an organizational chart 116 can be accessed as can enterprise mailing lists 118 and other such information sources. Based on a the policies set out for engine/filter 106 a user can be given access to enterprise information associated with users in the same directory 114, or perhaps users below the user on the organization chart 116. Access to the contact information of customers on the mailing list 118 may be limited to a particular branch of the organizational chart 116, or only users with a particular directory attribute 114. Other such examples will be detailed below. As the information is accumulated, new connections can be found based on the position of a user on the organization chart 116, or based on the other users who edit the same set of documents as indicated by directory repository 114 etc. These connections are provided to policy engine/filter 106 which enforces enterprise policies, as will be described below, to provide additional contact information to the aggregator 108. Aggregator 108 takes the social graph information provided by the multiple data sources and identifies overlapping entries in the social graph. Identification of the overlapping entries allows the aggregator 108 to build a more complete picture of users in the social graph 100, and builds a more complete indication of how people are connected. Thus, it may be possible to determine that someone is connected to the user through a connection on a first social networking site, as well as through a second connection on a second social networking site. This will allow the user to select the appropriate person to make an introduction. Alternatively it may allow a user to determine that a connection to someone is available through a co-worker who is not on the same set of social networking sites as the user.

As illustrated in FIG. 1, the plurality of social networking sites 110 are only one portion of the overall social graph information that can be collected. Enterprise data, including logs of email, instant messaging, and phone calls 112, corporate directories and directory information 114, org charts and mailing lists 118 can all serve as data sources to build an implicit social graph of who is connected to whom. Often this allows an individual to form a larger social graph based on a much larger contact pool. Though outside of an enterprise this may cause privacy issues, a corporation that owns all of its data can reasonably consolidate this information in a data source for access by its employees.

In an enterprise environment each employee typically has access to email. Each of these employees uses an outgoing corporate email server, which typically logs who individuals in the corporation have communicated with (both incoming and outgoing email). This information can also be obtained through an examination of email stored at any of a variety of servers. Similarly, instant messaging and phone logs can be used to obtain similar information. This information can form a communication repository 112 that can act as a data source from which social graph information can be built. One skilled in the art will appreciate that in addition to defining connections, such a data source can define the strength of a connection, in that determining that an employee had a one off email exchange with someone at another company can indicate that although there is a connection it is relatively weak, whereas a constant stream of messages between the same two individuals can indicate a much stronger connection. Mailing lists 118 can be mined for similar information (revealing both internal and external connections).

A corporate organizational chart (org chart) 116 can be used to show a user how they are connected to other individuals in the enterprise. This can be used to allow a user to find other people in the corporation, and determine whom they know in common, or it can be used to allow a user to find someone in the enterprise with a connection to someone of interest.

All these data sources can be subjected to a policy filter 106 that allows employees access only to information that they would otherwise be permitted to access. Someone at the top of the org chart 116 may have access to everyone's social graph information, but the inverse may not necessarily be true. Exceptions can be defined to various rules, for example, two employees may be able to access each other's social graph if they have corresponded with each other, but certain employees may be denied access to other employees social graph information regardless of whether they corresponded with someone or not. This would avoid the situation of an intern who has sent a report to the CEO to be given access to the CEO's social graph. Similarly a member of the HR team will not necessarily share their social graph simply due to communications with an employee.

The social graph 100, once assembled can be used as a source of contextually relevant data to be displayed to a user during the course of other activities. In one exemplary embodiment, a user can be provided a panel in which contextually relevant information about a webpage is displayed. Other embodiments can include display of contextual data associated with documents, or with email applications.

One skilled in the art will appreciate that an enterprise specific social graph can be created by a generator 102 that does not employ the social networking site interface 104. The resulting social graph would be focused on the connections and links that could be created through the enterprise data. This may be of greater interest to some enterprises than the information that would be added by the use of external social networks.

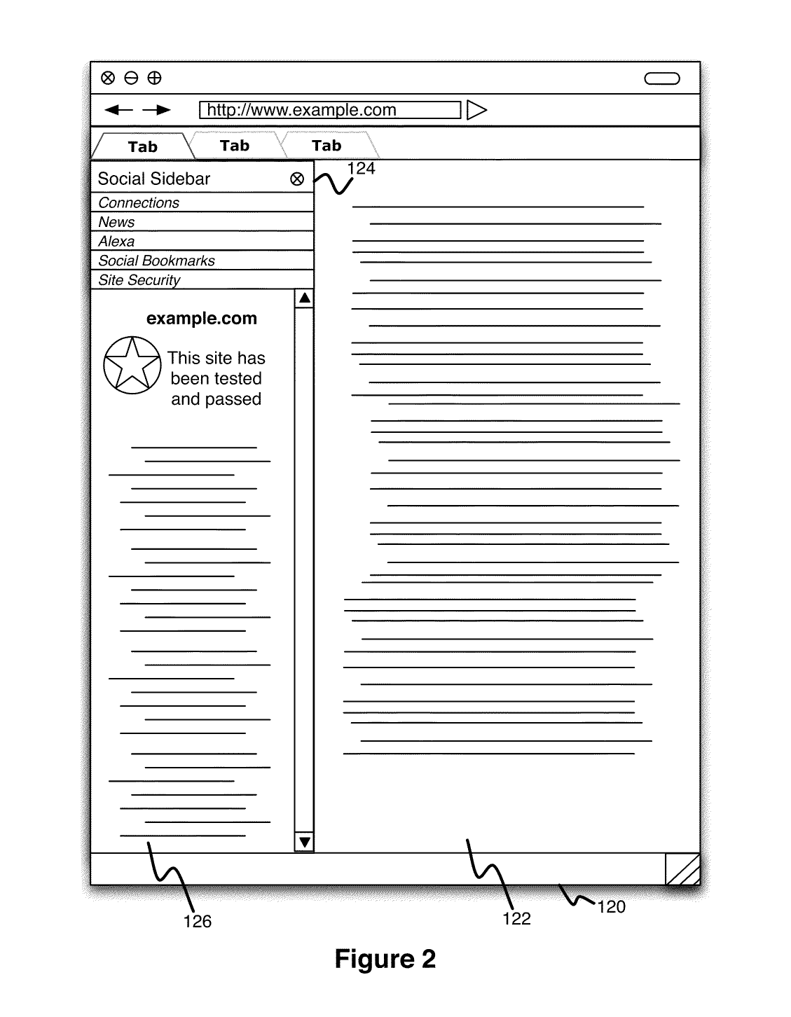

When a user views a document, contextual information can be provided using a variety of interfaces including a side panel as illustrated in FIG. 2. FIG. 2 illustrates a web browser 120 displaying a document 122. Those skilled in the art will appreciate that other applications can be employed in place of a web browser 120 without departing from the scope of the present invention. In a sidebar 124 a number of different panes can be displayed providing the user with different sets of relevant social graph information. One skilled in the art will appreciate that a pane can be omitted if there is no social graph information relevant for that pane to display. Whether empty panes are displayed is an implementation detail that can be changed without departing from the scope of the present invention. As illustrated in FIG. 2, a Site Security Pane 126 can be employed to show the user information about the site from an external resource, or set of resources. Those skilled in the art will appreciate that site security reviews can be obtained from a number of commercial and public resources, and that these reviews can either be displayed in this pane, or the information from these reviews can be processed to either create an aggregated view or a synthesized security rating. The mechanisms for how the security information is generated will be well understood by those skilled in the art.

As noted above, FIG. 2 illustrates an embodiment of the present invention as a side panel 124 in a web browser 120 that is displaying document 122. A web browser 120 is used to load a page 122, and contextual information 126 about the page 122 is provided to the user in side panel 124. Various panes are provided to the user to allow the user to view different types of contextually relevant information about the page 122 being viewed. One skilled in the art will appreciate that the present invention need not be implemented within a web browser, and instead can be an adjunct to other applications, such as CRM, document management, and email or groupware applications. Alternatively, the present invention can function as an independent window that works in conjunction with other applications such as web browsers, email clients, groupware applications, document management application and CRM applications.

Many computer displays now provide a user with a wide aspect ratio. Despite this fact, many applications and websites are designed for a conventional 4:3 aspect ratio. To make use of this additional horizontal space, vertical panes such as pane 126 can be displayed at the side of a screen or window to provide functional use for the wider screen.

New panes can be created using configuration data that can be stored as XML or JSON data or another data format describing how to obtain contextual data. Topic information about a page can be determined by the present invention using intrinsic document data as well as metadata associated with the document such as the domain in which a document resides, the URL of a page, a pattern in a page (such as an email address, a phone number, a postal address, a URL or other domain information). In certain embodiments, the topic of a page is determine in accordance with specified information so that an intranet page will only determine topics based on the URL, or a defined topic tag, or so that CRM data has a topic determined solely by the contact information. When context information is requested, the configuration of a tab allows for the predetermination of how any authentication is handled. Formatting and transaction information including summary information, detailed information, icons, images and layout templates, and whether this data is obtained in one call or multiple calls, can also be defined in the panel configuration file.

The configuration of a panel can also specify how the panel will react under certain circumstances. A pane can indicate that metadata of a sufficient level of importance can cause the panes to re-order so that the information is displayed immediately. An example of this is discussed below.

FIG. 2 illustrates a site security metadata panel. When the user has navigated a web browser 120 to a page 122, security information 126, such as that available from outside vendors, or other third parties, can be displayed. The site status can be prominently displayed with other less important information displayed below. If the user hides this pane and then navigates to a page which has a poor security ranking, the pane can detect that a threshold has been breeched and the security pane 126 can be brought to the foreground. This provides the user with more information, and in a more digestible format than a small icon indicating that encryption has not been properly enabled. The site security message can also alert users to threats of phishing being run out of a particular site, if such information is available.

In addition to alerting a user about possible security risks, the social graph information can be used to determine if the site is operated by someone who is already determined to be trustworthy, so that this mitigating information can be displayed to the user. Similarly if a user is the administrator of the page, any change in the security ranking of the site can trigger the panel being raised to the front of the stack of panels.

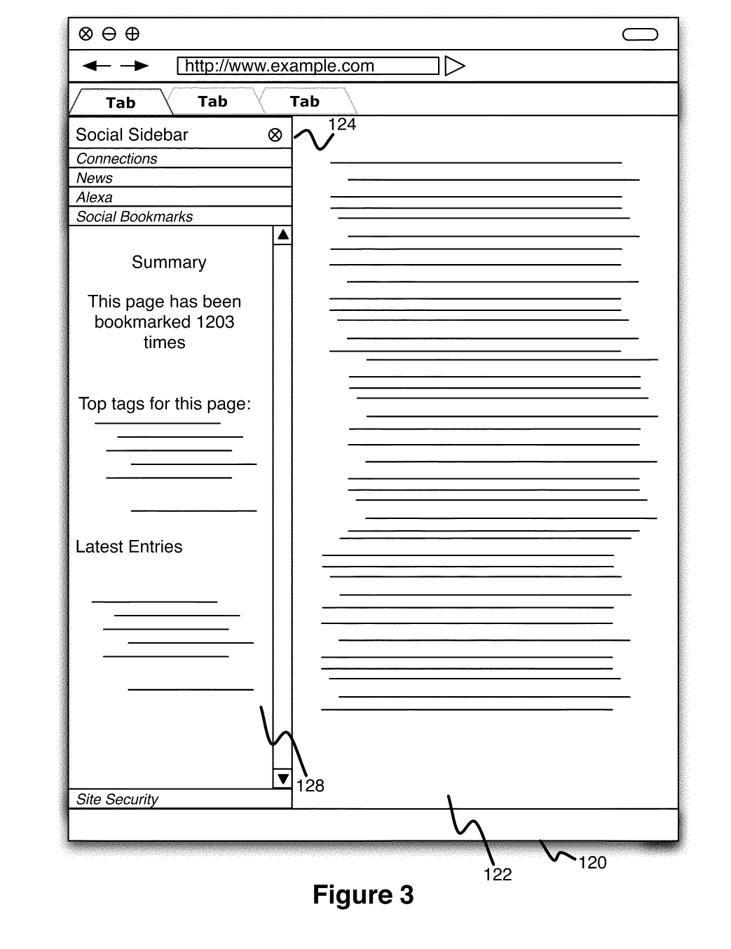

FIG. 3 illustrates the same page 122 in browser 120 after the user has selected the Social Bookmarking pane 128. Pane 128 can allow the user to see information about the page from a social bookmarking sight such as del.icio.us. Other users of the social bookmarking service that are in the user's social graph serve as the basis for the summary information. The number of connections that have bookmarked a page can be displayed, as can any of the tags that were used to describe the page. Other information including how often the general public bookmarked a page and the tags generally associated with the page can be displayed, as can the most recent contacts to have bookmarked the page. The information about how individuals in the social graph or the extended enterprise social graph have treated the page can provide a user with information about how relevant a page is, and about what on the page is of particular interest.

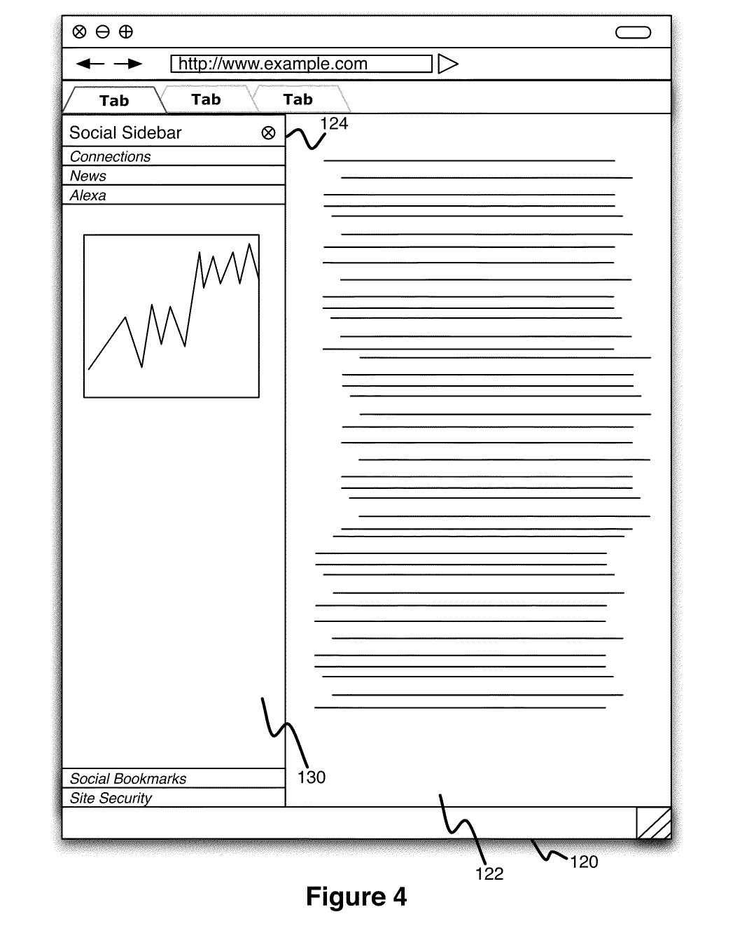

A traffic analysis pane 130 (FIG. 4) can be displayed beside page 122 in browser 120 using either general internet traffic reporting, as would be shown by a site such as Alexa.com on a domain level, or using analytics information provided by a site analytics service if available to the user. A sudden spike in the traffic associated with the page could be used as a trigger to bring this panel to the foreground. Users of social networking services that have demographic information stored can provide demographic information to an analytics service so that a user with access to analytics information can also obtain demographic information about the audience.

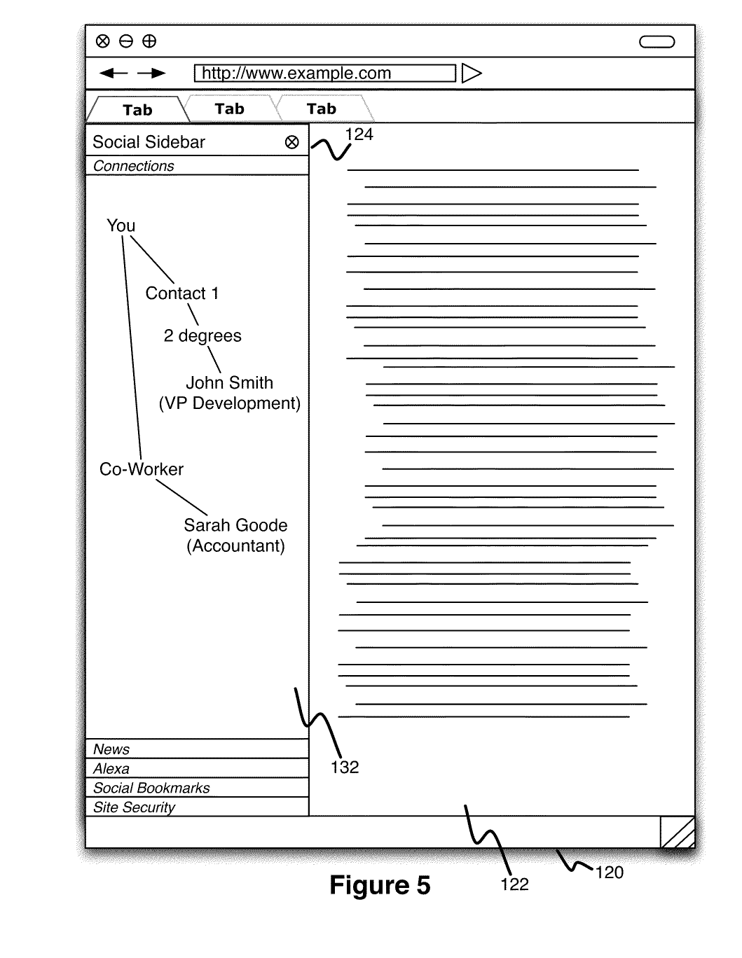

A social connections pane 132 (FIG. 5) can identify people in the social graph associated with the topic of the page 122, and a graph showing how the user is connected to these people can be shown in the browser 120. Links between people can have associated strengths, based on factors such as the frequency of contact between the people in an enterprise context, and the number of social networking connections there are between two people. The people identified as relevant to a page can be determined in a number of ways. If the page provides an email address or other identifying information associated with a person, that person's position on the social graph can be shown. If the page is about a company, any people in the user's social graph associated with the company can be shown.

In the enterprise environment, links can also indicate how the contacts are made, so that email, social networking, phones and instant messaging are all shown differently. If a co-worker is connected to someone associated with a company, and that person's (e.g. Sara Goode) contact information is stored by the co-worker, a link to the address book entry can be provided.

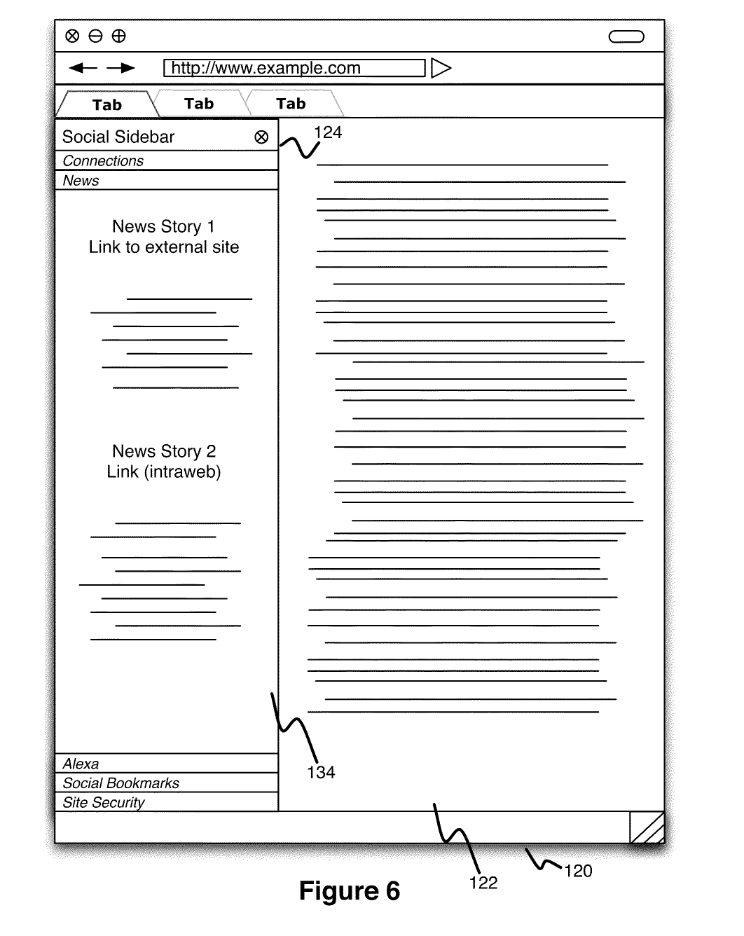

In FIG. 6, a news panel 134 is illustrated. News stories about the topic of a page 122 (e.g. a person or a company) can be displayed in side panel 124 of browser 120. If page 122 is associated with a publicly traded company, alerts can be set for large changes in stock prices, or based on the number of news stories available in a 24 hour period (for example). Stories that have been bookmarked or flagged as important by contacts (possibly using social bookmarking sites such as those accessed in pane 128 of FIG. 3) and their connections can be highlighted or more prominently displayed.

In one embodiment, a default pane can be configured by the user to display information, such as an aggregation of RSS feeds, social network status updates and other such information (including an alert for new email messages) when no contextually relevant information related to a page can be found that is of sufficient interest. This user definable pane provides the ability to display advertising to the user if desired to obtain an advertising revenue stream, and provides the user with an incentive to keep the pane open. If another pane is activated in response to an alert or warning, and is ignored by the user for a sufficient amount of time, the default pane can be returned to the foreground.

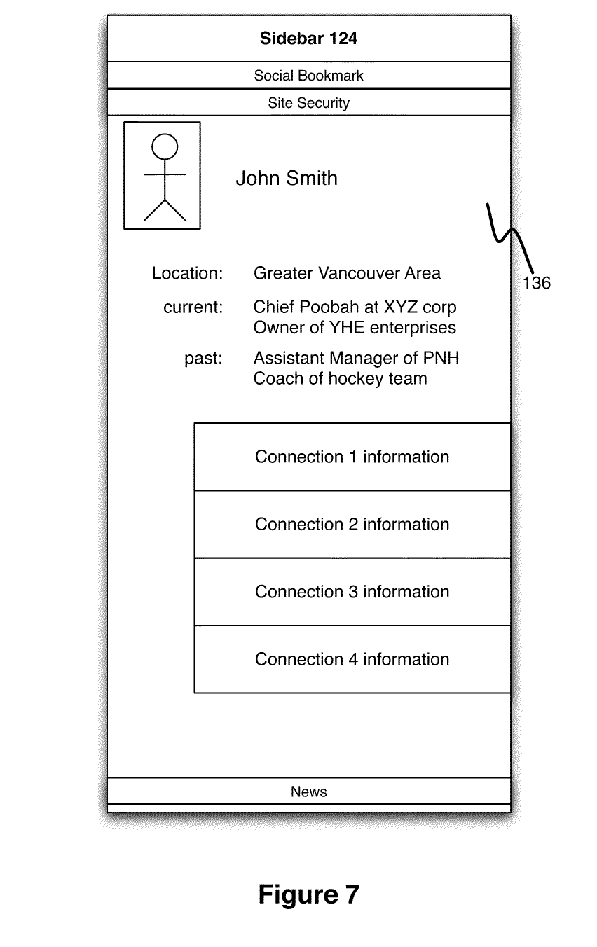

FIG. 7 illustrates side panel 124 showing contact information for a particular conection in a pane 136. Pane 136 can show not only the information available in an address book or through a social network, but preferably shows an aggregated view of the contact information for the particular connection. This pane can be displayed when content particularly relevant to the connection is viewed by the user. In the context of a website, this information can be shown when the user visits a page associated with the user such as a blog written by the user, or the corporate website of the employer of the connection. In an enterprise setting a document that makes distinct reference to the connection or a document created or owned by the connection will bring the contact pane to the fore when accessed. This allows the user to easily obtain contact information for a relevant user.

FIG. 7 illustrates a presentation format that can also be used in an embodiment of the present invention to display information about how a person is connected to the user in the social connections panel. The presentation of the social connections panel when the user navigates to a page associated with a person, and then selects the person in the panel. The subject's profile from a social networking site is displayed, and the people who form the connection between the individual and the user are shown below. The person shown is connected to the user through four individuals on the same social networking site, and is connected directly to each of the four contacts. By showing photos associated with the different users along with a graphical representation of how the connection is make and the network the connection is made through, a large amount of complex information is shown simply.

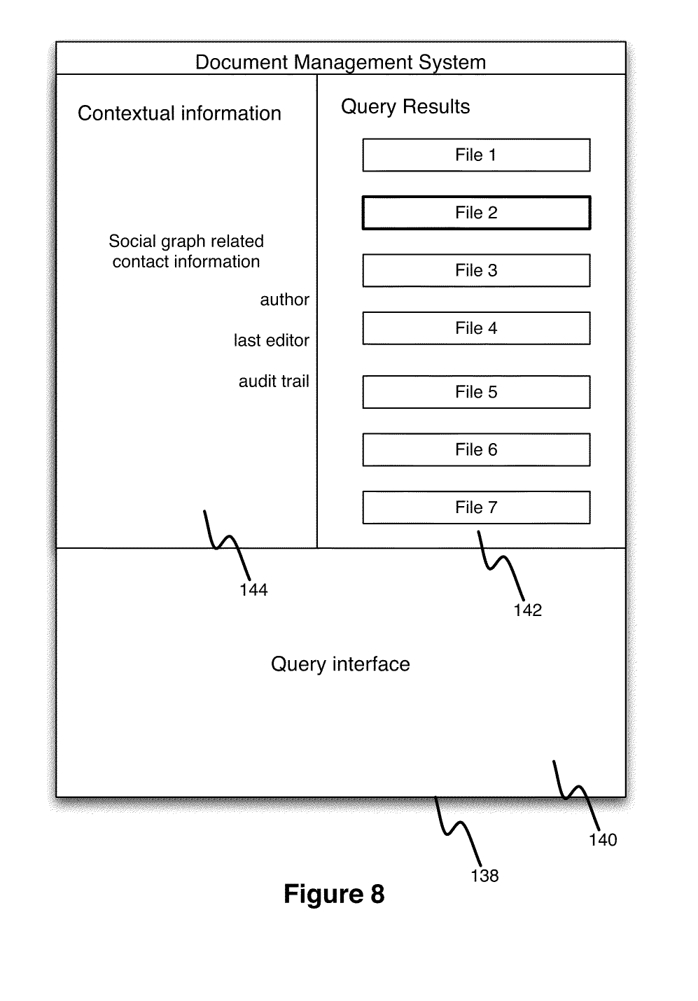

In an enterprise environment, access control information, obtained from sources such as directory permissions, file management systems and other such resources can be displayed. In a conventional document management system, a user can execute a search to find a document, and can then issue an explicit command that allows him to view the history of a file. Although this is sufficient for audit purposes, it does not provide the average user with any useful information. Because access control and document management systems track access by individual users along with information related to the particular user that edited a document, and the time at which it is done, this information can be provided as contextual information, subject to enterprise filtering for policy purposes. Thus a document management system can be made enterprise social graph aware. Such as document management system is illustrated in FIG. 8. Document Management System 138 allows a user to execute queries to find files using query window 140. One skilled in the art will appreciate that a file manger that allows a user to browse the stored documents instead of requiring a query could also be implemented without departing from the scope of the present invention. After a query is executed, a set of results is shown in results window 142. When a user selects a document, such as File 2, a contextual information pane showing contextual information and social graph information can provide the user with information about who in the enterprise created the document, and who has subsequently edited or viewed the document. This information can be provided to the user along with the social graph information required to allow the user to determine how they are connected to these individuals. The social graph information can be provided to the user when the clicks on a particular name resulting in an interface such as that illustrated in FIG. 5 as pane 132. Additional social graph information can be provided if there is sufficient information in the document to allow the contextual display system to determine either a topic, or additional contact information. If a topic can be identified, the user's social graph can be inspected to determine experts in that field, or if an individual's email address is provided, the contact information can be used to see if the user is connected to the person associated with the email address.

This in depth analysis functionality using intrinsic and extrinsic contextual information about a document, and the related social graph information can be used to build an audit tool around the contextual information. The audit tool can allow tracking of all user access based on a document identifier such as a uniform resource locator (URL) or uniform resource indicator (URI). Someone with sufficient access rights who accessed the document could then see who has accessed the document as contextual information in a sidebar such as sidebar 144 without needing to separately access the information. The fact that casual viewing of a document can be seen by the next authorized person to view a document provides a deterrent for people to view documents that they have no need to access. For example, a patient record in a hospital should be accessible to all doctors, but doctors who are not treating that patient have very little reason to view the record. If a primary care physician is unavailable, and another doctor views the record, the record inspection is displayed in the contextual information sidebar 144 during the next viewing of the record. The primary care physician can then determine that the viewing was done for a particular purpose. However, if there was no justification for the viewing of the record, an investigation can be undertaken. In the physical world, doctors do not view records that they don't have a need to review because they can be physically seen doing so. This exerts a social pressure to conform to the rules. By maintaining an audit trail in the contextual information the social pressure is replicated in a digital domain. Although the contextual information showing an audit trail can be accessed by users through conventional document management systems, it often remains hidden, and is only available for documents stored in the document management system. In a collaborative environment making use of web-based applications such information is often inaccessible to most users. Without a mechanism to easily view this information, it effectively remains lost. When this information is presented as contextual information in a panel 144 that can be displayed beside the document or the search results 142 in the conventional application used to view the information, the audit trail becomes publicly viewable (to authorized users) and the ability to view the data is separated from having access to a document management system. Access to documents and topics associated with documents can be determined using the URL of the document, or another unique identifier associated with the document. When using web-based applications unique identifiers are often associated with a file even when not shown to the user. If presented in panel 144, the audit information becomes another type of contextual information that then becomes familiar to the user. A pane used to display this information in sidebar 144 can be made to rise to the top of a stack of panes and present the user with an alert if the audit information contains exceptional data. The function of a panel providing an alert will be discussed below in more detail

From the perspective of a user viewing customer relations management (CRM) data, the enterprise-based social graph can allow the user to determine which other employees are connected to an existing or a potential customer. When a contact in a CRM system is accessed, the social graph panel can access the social graph built from the communications by any or all of phone, email and instant messenger, and determine who in the enterprise has a relationship with an individual or corporation in the CRM system. Although the content of the messages between two entities may not be visible or available to a third party, the fact that they have communicated with each other is used to determine that there is a connection that can be shown. This allows the social networks of each employee in the entire enterprise to be harnessed to build and foster customer relationships. The frequency and context of connections and communications with a customer can also be used to obtain other information that may escape notice. If, in a short period of time, the rate with which connections are being made to a customer increases, and the frequency of communication with the customer is also increasing, contextual information about the customer in the CRM system will indicate the increase in the number of contacts as an alert in the side panel. A rapid increase of this sort may indicate that a customer is having support issues, and an increase in the number of employees dealing with a customer may indicate that the customer is being routed to many different groups in an attempt to solve an issue. These issues can then be resolved after they have been identified through the contextual information.

Access control to many resources in an enterprise is often centrally maintained. If a user attempts to access an access-controlled document to which she does not have access, in the prior art, the request is denied, and the user is required to determine how access can be obtained. Making use of contextual information available through directory services, such as LDAP which can be one of the directory services accessed as an element in directory repository 114 of FIG. 1, contextual information can be provided to the user about the access controlled document. This information can include the person, or people, to contact to gain access to the document, and where that person or people fit in the social graph of the enterprise. Other information including whether the access controller is online, or unavailable can also be presented, as can an interface through which the user can request access to the document. The access request interface can also provide the user with the terms and conditions that access is provided under. The interface can provide the administrator with a message that allows simplified management of access control, including the ability to temporarily provision access to the user. One skilled in the art will appreciate that this can be implemented by determining in a processor that a particular event, in this case an access control failure, has occurred, and based on the resource, the type of failure and information associated with the resource a set of contextual information is then presented to the user.

Provisioning of access to a user is often time consuming, as is the process of removing users from access control lists. This is especially true when access is maintained by a legacy system. The ability to obtain social graph information can be used by automated processes in an enterprise to remedy this situation. For the occasional users of an access controlled resource, a series of guest accounts in the legacy system can be created. When a user attempts to access the resource without having been provisioned access, an access request can be initiated. If the user is only seeking temporary access, or if the administrator wants to provide temporary access until full access can be provisioned, the user can be provided access to one of the guest accounts. The user's social context can be provided to an access gateway that will map the user's social context information to one of the guest accounts. The access gateway can then log the times at which the guest account is accessed by various different users. The social context of the user provides information to the administrator and the access gateway that indicates that the user should have access to certain features based on their position and relevance in a company. Two different users may be given access to different guest accounts with different access rights, or they could be given access to the same guest account if they are to be given the same access rights (or they could be given access to different guest accounts that have the same access rights). The use of the social context of the user is thus used to determine access rights until a permanent provisioning is made. At such a time, the user can be seamlessly transitioned to the permanently provisioned account.

In the above description, the notion of using the panes to display alerts to the user was discussed. When a user browses documents or web pages in conjunction with the present invention, the last panel used remains at the top of the stack. For example, if the user was viewing the site security information on a first webpage and then navigates away to another webpage, the site security panel will remain active and will simply provide the information of the next page that is viewed. However, in the configuration of a panel, an alert feature can be offered. The alert is typically associated with a particular type of data displayed by the panel. If the contextual information is exceptional, and exceeds a defined threshold, the panel displaying that information can be brought to the user's attention. Typically this is done by forcing the panel to the top of the stack, but it can also be done in other ways including issuing a visual alert that may include changing the color or flashing the title bar of the panel. Some examples of alerts include a news panel generating an alert if a predefined number of news stories are generated in a fixed period of time, or if a stock price associated with the company that a viewed page is about changes by more than a threshold. In the site security panel, an alert may be generated if the site security rating of a page has changed since the last viewing or if the site security is indicative of a disreputable site that has never been visited before. In the traffic analysis tab, if a site has received a spike in traffic flows an alert can be generated.

These alerts are specific to the page or document that is being viewed. In an example the user is at a first website and selects the social bookmarking tab. This shows the user other people who bookmarked the page and the tags used by these people. The user then types a new domain in to the address bar, and views a corporate website. If the company has recently suffered a stock price collapse, the news panel can generate an alert and comes to the top of the stack of panels. If the user does not take any action, the news panel sinks to its previous value and the social bookmarking tab comes back to the front of the stack. The user then navigates to a page that has poor security, and has had a spike in traffic recently. Both the security panel and the traffic panel generate alerts. A resolution mechanism is applied, and one of the panels is displayed at the top of the stack, but the panel title bar of the other panel flashes to indicate that an alert is available. The user then examines the alert at the top of the panel, and decides to dismiss this instance of the alert. This allows the other panel with an alert to rise to the top. The user can review the alert and decide to turn off alerts of this type so that they are not raised again. This has the effect of tuning the alert feature so that certain types of exceptions are not treated as exceptional.

The user can decide that the panels are not needed on a permanent basis, and can hide the panels, and then call them back when contextual information is required. If a panel generates an alert when the panels are not displayed, a notification message, can be displayed on the user's screen using any of a number of different techniques including a notification bar at the top of a browser or other application window, or through a pop up display window.

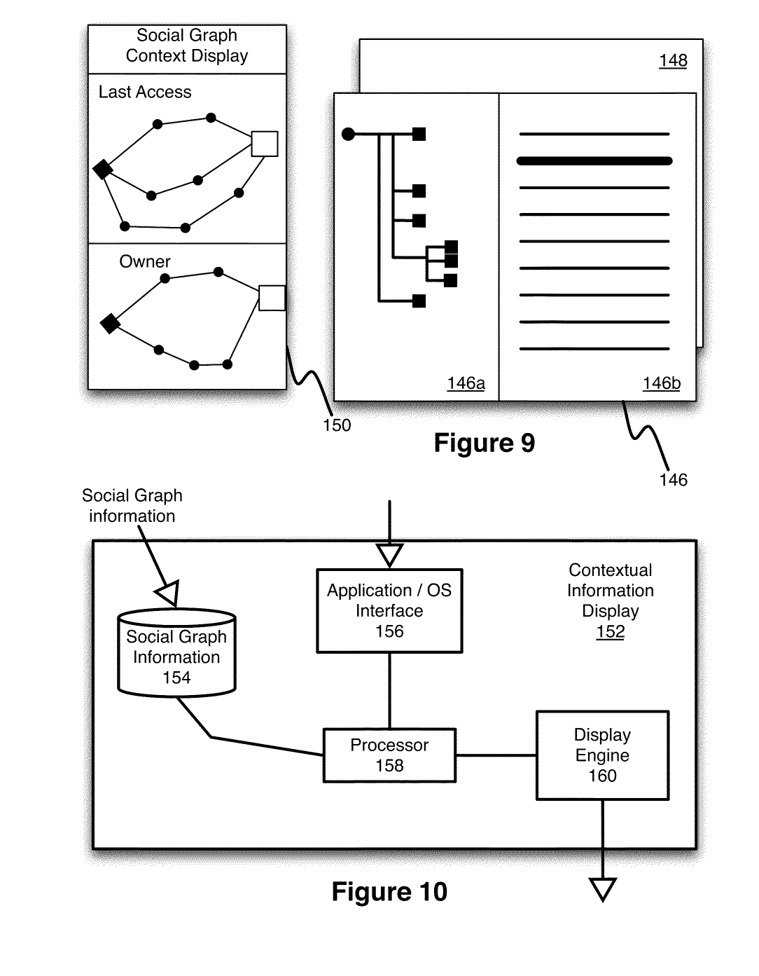

FIG. 9 illustrates another exemplary embodiment of the present invention. As before, a representation of contextual information, using social graph information where appropriate, is displayed to provide the user with additional information about the object of user focus. In the illustrated embodiment, user applications 146 and 148 are run, and the user focus is presently help by application 146. Application 146 is a file management application that in the present exemplary embodiment displays a directory tree in pane 146a and a file listing in pane 146b. One of the files listed in pane 146b has been selected by the user. The user selecting a file clearly indicates user focus, and stand-alone application 150 displays contextual information based on the intrinsic and extrinsic metadata about the file and related social graph data where appropriate. Thus, the standalone application 150 can show the last person to edit the file as well as the owner of the document. This information can be obtained from a document management application that is not illustrated. The connections between the user and any relevant individual can be obtained through an examination of the social graph. Additionally the name of the last editor or document owner, or any other such relevant individual, can be presented as a hyperlink so that the user can either find out more information about the individual or can send an email to the person without great effort. The manner in which the contextual information is displayed can be varied without departing from the scope of the present invention.

FIG. 10 illustrates an exemplary embodiment of a system of the present invention for displaying contextual information to the user. One skilled in the art will appreciate that this system can be a standalone application, a module in another application, or a plugin to an application (e.g. a plugin to a web browser). The contextual information display 152 includes a database of social graph information 154 (though one skilled in the art will appreciate that this database need not be incorporated in the produce and can exist as an external resource called on by the application), an application or operating system interface 156 (which may be omitted if the product is sufficiently integrated into either the operating system or an application), a processor 158 and a display engine 160. The processor 158 receives an indication from the interface 156 that the user has focused on a particular file. This can be determined by the user clicking on a file in a file management application, or by having the user load a document, or open a webpage. Those skilled in the art will appreciate that there are a number of other mechanisms for determining the user focus that can be used. The processor then obtains any available intrinsic or extrinsic metadata about the object of the user focus. In some embodiments this information is also provided by the application/operating system interface 156. Based on this contextual information, the processor requests social graph information from database 154 and creates a data set of contextual information associated with the object focused on by the user. This data set is provided to display engine 160 for rendering to an application window, such as application 150 in FIG. 9 or pane 124 in FIG. 3.

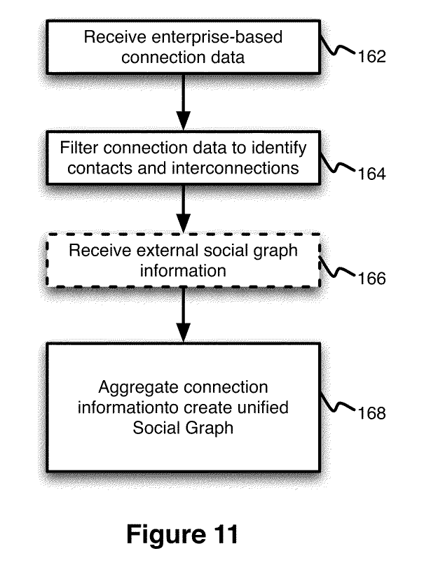

FIG. 11 is a flowchart that illustrates an exemplary embodiment of a method for generating a social graph using a system such as the one illustrated in FIG. 1. In step 162, enterprise based connection data is received. As noted earlier, this data can come from a number of different enterprise sources. The connection data is filtered to identify contacts and interconnections in step 164. One skilled in the art will appreciate that the filtration of the connection information can be done in accordance with information obtained in step 162 (e.g. filtering connections based on a position in an org chart or based on information in a directory repository). Optionally external social graph information is obtained in step 166. Finally, aggregation of the connection information from the enterprise sources and optionally the external social networks is performed in step 168 to create a unified social graph.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An enterprise social graph generator for generating a social graph for a user comprising:
an enterprise data filter for receiving information from a plurality of enterprise specific data sources and for providing as an output, contact information extracted from the enterprise specific data sources in accordance with a set of policies determined in accordance with an identity of the user; and
a social graph aggregator for receiving the extracted contact information from the data filter and for creating a social graph based on connections to the extracted contacts, the graph ordered based on the proximity of each of the contacts to the user, each contact being directly connected to either the user or another contact.

2. The generator of claim 1 further including a social network interface for obtaining social graph information associated with the user from at least one external social networking site, and for providing the obtained social graph information to the social graph aggregator for use in creating the graph.

3. The generator of claim 2 wherein the social graph aggregator includes means to identify duplicate connections to a contact, and means to express a connection strength based on the number of connections to a contact.

4. The generator of claim 1 wherein the filter includes an interface for receiving enterprise specific information from a repository of communication logs.

5. The generator of claim 4 wherein the repository of communication logs includes connection information obtained from at least one of telephone calls, instant messages and email messages.

6. The generator of claim 1 wherein the filter includes an interface for receiving enterprise specific information from a repository of directory information.

7. The generator of claim 6 wherein the repository of directory information includes Lightweight Directory Access Protocol information.

8. The generator of claim 1 wherein the filter includes an interface for receiving enterprise specific information from an organizational chart.

9. The generator of claim 9 wherein the filter employs information from the organizational chart to user access rights to information obtained from other enterprise data sources.

10. The generator of claim 1 wherein the filter includes an interface for receiving enterprise specific information from mailing lists.

11. A method of creating a social graph for a user based on enterprise specific data, the method comprising:
receiving enterprise based connection data;
filtering the received connection data to identify connections between the user and contacts contained in the received connection data; and
aggregating the identified connections to form a social graph.

12. The method of claim 11 wherein the step of receiving includes receiving enterprise based connection data from a plurality of data sources.

13. The method of claim 12 wherein the plurality of data sources include a messaging repository, a directory repository, a mailing list and an organizational chart.

14. The method of claim 13 wherein the step of filtering includes excluding information received from the plurality of data sources based on the user's position in the organizational chart.

15. The method of claim 11 wherein the step of aggregating the identified connections includes identifying duplicate connections to contacts and indicating the strength of connections to contacts.

16. The method of claim 11 further including the step of receiving social graph information from at least one external social networking site and incorporating the identified connections in the received social graph with the identified connections from the received enterprise data prior to the step of aggregating.

17. A contextual information display for displaying contextual information based on metadata and social graph information, the display comprising:
a social graph information database for receiving and storing social graph information;
an external interface for receiving an indication of user focus;
a processor for obtaining the indication of user focus from the external interface, for obtaining contextual information about the object of the user focus, for querying the social graph information database for social graph information relevant to the obtained contextual information and for creating a context sensitive data set for display; and
a display engine for rendering the context sensitive data set on a display.

18. The display of claim 17 wherein the display engine includes means for displaying the context sensitive data in a standalone application while the object of the user focus is in a distinct application.

19. The display of claim 18 wherein the processor includes means to process file access and ownership information as contextual information and to query the social graph information database for social graph information related to the identity of users who have accessed, modified and have ownership of a file indicated as the object of the user focus, and wherein the display engine includes means for rendering audit information in a window of the standalone application.

20. The display of claim 17 wherein the context sensitive information includes social graph information associated with intrinsic and extrinsic contextual information obtained about the object of the user focus.
